(19) United States
(12) Patent Application Publication
(10) Pub. No.: US 2015/0336415 A1
(43) Pub. Date: Nov. 26, 2015

(54) BOTTLE INTERFACING GREETING CARDS, METHODS OF MANUFACTURE AND METHODS OF USE

(71) Applicants: John Fetters, San Francisco, CA (US); Kathleen Fetters, San Francisco, CA (US)

(72) Inventors: John Fetters, San Francisco, CA (US); Kathleen Fetters, San Francisco, CA (US)

(21) Appl. No.: 14/712,789

(22) Filed: May 14, 2015

Related U.S. Application Data
(60) Provisional application No. 62/001,612, filed on May 21, 2014.

(51) Int. Cl. B42D 15/04; G09F 3/04; B31D 1/00; G09F 1/04

(52) U.S. Cl. CPC B42D 15/042; G09F 1/04; G09F 3/04; B31D 1/00

(57) ABSTRACT

Bottle interfacing greeting cards and methods of use and manufacture are provided herein. An example greeting card includes a folded substrate forming a front section and a back section, the front section having a front surface and the back section having a rear surface, and an interface tab configured to slip over a neck of a bottle, the interface tab extending from either the front section or the back section wherein a perforated line separates the interface tab from the folded substrate such that the folded substrate is detachable from the interface tab to form a greeting card.

### CROSS REFERENCE TO RELATED APPLICATIONS

This application claims the priority benefit of U.S. Provisional Application Ser. No. 62/001,612, filed on May 21, 2014, which is hereby incorporated by reference herein in its entirety—including all references and appendices cited therein.

### FIELD OF THE INVENTION

The present technology pertains to greeting cards and more particularly, but not by limitation to greeting cards that are configured to interface with a bottle. The greeting cards can include an interface tab that interfaces with the bottle. The greeting card body can be detached from the interface tab.

### SUMMARY

According to some embodiments, the present technology is directed to a greeting card, comprising: (a) a folded substrate forming a front section and a back section, the front section having a front surface and the back section having a rear surface; and (b) an interface tab configured to slip over a neck of a bottle, the interface tab extending from either the front section or the back section wherein a perforated line separates the interface tab from the folded substrate such that the folded substrate is detachable from the interface tab to form a greeting card.

According to some embodiments, the present technology is directed to a greeting card, comprising: (a) a folded substrate; and (b) an interface tab configured to slip over a neck of a bottle, the interface tab extending from the folded substrate, wherein a perforated line separates the interface tab from the folded substrate, wherein the folded substrate bends and is disposed at an angle relative to the interface tab when the interface tab is placed over the bottle.

According to some embodiments, the present technology is directed to a greeting card, comprising: (a) a folded substrate forming a front section and a back section defined by a folding line, wherein the front section comprises a bottom edge, opposing side edges, and a top edge, wherein the top edge comprises: (i) a two linear sections that are parallel to the bottom edge; (ii) an arcuate tab that extends between the two linear sections, the arcuate tab comprising an aperture, wherein the arcuate tab comprises an aperture that receives a neck of a bottle; and (iii) perforated line extending between, and in alignment with, the two linear sections, the folded substrate detachable from the arcuate tab along the perforated line.

According to some embodiments, the present technology is directed to a greeting card product created by a process, the process comprising: (a) obtaining a substrate, the substrate comprising a midline axis; (b) forming an interface tab on one side of the midline axis, the interface tab comprising an aperture that receives a neck of a bottle; and (c) folding the substrate along the midline axis to form a greeting card product.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of an example greeting card product constructed in accordance with the present technology.

FIG. 2 is a front elevational view of another example greeting card product of the present technology.

FIG. 3 is a perspective view of an example greeting card, created from the greeting card product of either FIG. 1 or FIG. 2.

FIG. 4 is a side elevational view of an example greeting card product in combination with a wine bottle.

FIG. 5 is a front elevational view of an example greeting card product in combination with a wine bottle.

FIG. 6 is a perspective view of an example greeting card product illustrating the relationship between an interface tab and a front section of the greeting card product.

FIG. 7 is a top down view of an example substrate used to create a greeting card product.

FIG. 8 is a top down view of a greeting card product blank created from the substrate of FIG. 7.

FIG. 9 is a perspective view of a greeting card product created from the process illustrated in FIGS. 7 and 8.

FIG. 10 is a front elevational view of an example greeting card product with indicia imprinted thereon.

FIG. 11 is a front elevational view of an example greeting card product with instructions for removing an interface tab.

FIG. 12 is a front elevational view of an example greeting card product having front and back sections of differing size.

FIGS. 13-20 each illustrate a front elevational view of an example greeting card product having a unique type of aperture.

FIG. 21 is a front elevational view of an example greeting card product having an interface tab with an aperture disposed towards a top thereof.

FIG. 22 is a front elevational view of an example greeting card product having an interface tab with an aperture disposed towards a bottom thereof.

FIG. 23 is a front elevational view of an example greeting card product having an interface tab that is disposed on a first side of a front section.

FIG. 24 is a front elevational view of an example greeting card product having an interface tab that is disposed on a second side of a front section, opposite to what is illustrated in FIG. 23.

FIG. 25 is a diagrammatical representation of a process for using an example greeting card product.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity having any relationship to the subject matter of the present disclosure.

Generally, the present technology is directed to greeting card products that are configured, adapted, or manufactured to interface with a bottle. In one embodiment, these greeting cards interface with a neck of a bottle. In some embodiments, the greeting cards include an interface tab that receives the neck of a bottle. An example greeting card product includes a greeting card portion and the interface tab. The greeting card portion can be removed or detached from the interface tab to create a greeting card. These and other advantages of the present technology will be described below with reference to the collective drawings.

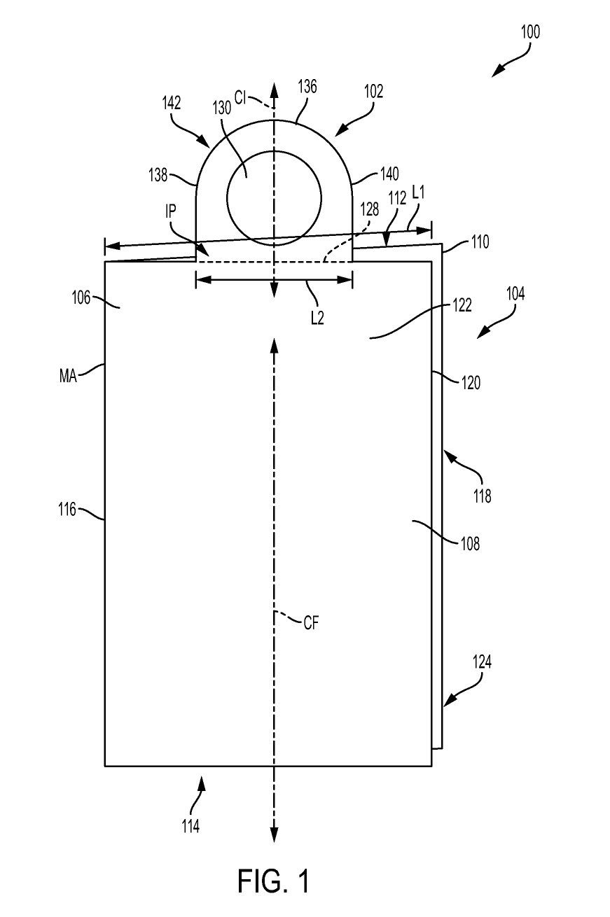

FIG. 1 illustrates an example greeting card product (e.g., greeting card) 100 that includes an interface tab 102 and a greeting card portion 104. In general, the greeting card product 100 is formed of a substrate 106. The substrate 106 can comprise any suitable material such as paper, a textile, a cardstock, a laminated paper, a plastic, or other similar material that would be known to one of ordinary skill in the art with the present disclosure before them.

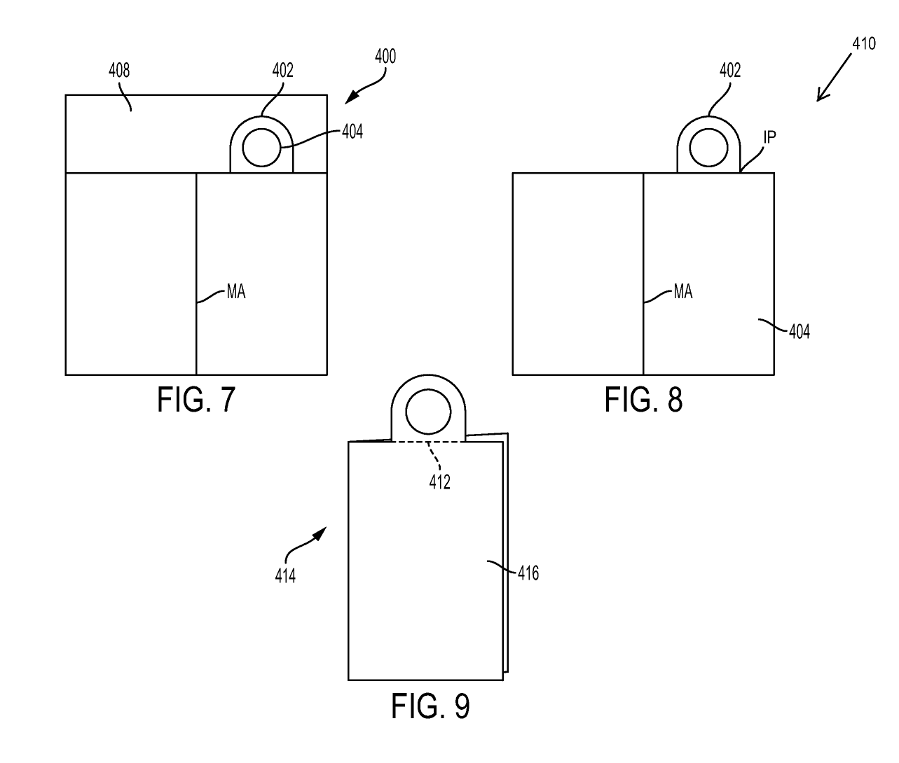

In some embodiments, the substrate 106 comprises a front section 108 and a back section 110, which are delineated by a midline axis MA. Substrate 106 also generally comprises a top surface 112, a bottom surface 114, and two opposing sides 116 and 118. The midline axis MA is best illustrated in an example greeting card product manufacturing process illustrated in FIGS. 7-9.

The front section 108 and the back section 110 can include an inner surface, such as inner surface 120 of the back section 110. The inner surface 120 can be configured or adapted to allow for writing of indicia thereon. In one embodiment, when the substrate 106 is manufactured from a cardstock, the inner surface 120 is inherently configured to allow for writing of indicia thereon. In another embodiment, the inner surface 120 is provided with a coating or layer that receives written indicia. This configuration is advantageous when the material used to create the substrate 106 is a plastic or other material that is not conducive to receiving written indicia.

The front section 108 comprises a front surface 122 and the back section 110 comprises a back surface 124. Each of the front and back surfaces 122 and 124 can receive a decorative or ornamental design and/or message.

The interface tab 102 is attached to the greeting card portion 104. In some embodiments, the interface tab 102 and greeting card portion 104 are releaseably detachable from one another. For example, an interface point IP between the interface tab 102 and greeting card portion 104 is defined by a perforated line 128. The greeting card portion 104 can be torn away from the interface tab 102 along the perforated line 128.

In other embodiments, the interface tab 102 extends from the greeting card portion 104 in such a way that the interface tab 102 can be folded at an intersection point IP with no perforations. The interface tab 102 and greeting card portion 104 remain joined until the interface tab 102 is separated from the greeting card portion 104 by, for example, cutting the greeting card portion 104 away from the interface tab 102 with scissors, knife, or other cutting implement.

Other methods for releasably joining the interface tab 102 and greeting card portion 104 are also likewise contemplated for use. For example, the interface tab 102 and greeting card portion 104 can be releaseably attached to one another with an adhesive. The adhesive can be selected from any adhesive that allows the interface tab 102 and greeting card portion 104 to release from one another without damaging the greeting card portion 104. The interface tab 102 can be adhesively attached to either the front section 108 or back section 110 of the greeting card portion 104.

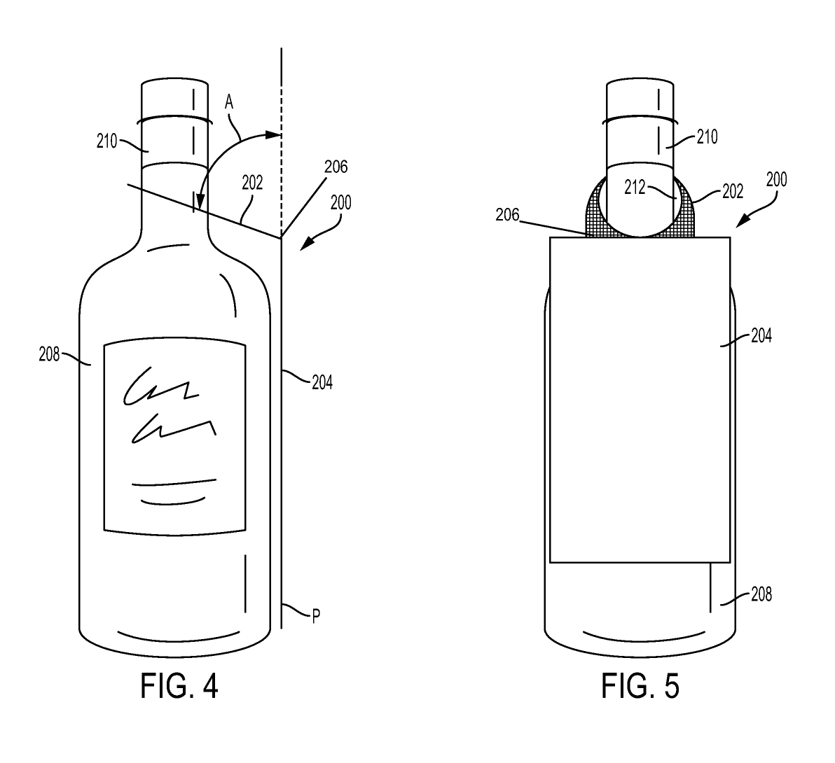

In some embodiments, the interface tab 102 comprises an aperture 130 that is sized or otherwise configured to receive a neck of a bottle (see FIGS. 4 and 5). An example wine bottle is illustrated but it will be understood that the aperture 130 can be sized to accommodate for any type of bottle neck.

In some embodiments, the interface tab 102 includes an arcuate section 136 and linear opposing sides 138 and 140. In one embodiment, a centerline CI of the interface tab 102 and a centerline CF of the front section 108 are substantially aligned with one another. Thus, the interface tab 102 lines up with a middle of the greeting card portion. To be sure, the interface tab 102, in some designs can be offset from the greeting card portion such that the centerline CI of the interface tab 102 and the centerline CF of the front section 108 are not in alignment with one another.

In some embodiments, the top surface 112 of the front section 108 has a length L1. The interface tab 102 also has a length L2. In some embodiments, the length L2 of the interface tab 102 is shorter or less than the length L1 of the front section 108.

In accordance with the present disclosure, the interface tab 102 can be configured to incorporate a substantially arcuate outer peripheral edge 142, which allows the interface tab 102 to correspond with the shape of the bottle, preventing the interface tab 102 from catching on other objects and releaseably detaching itself from the greeting card portion 104.

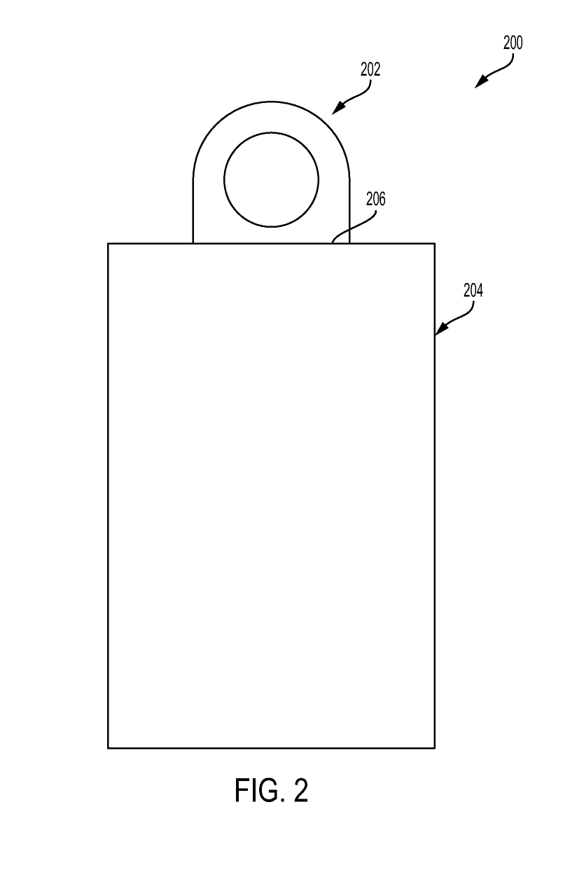

FIG. 2 illustrates another example greeting card product 200 constructed in accordance with the present disclosure. The greeting card product 200 comprises an interface tab 202 and a greeting card portion 204 (e.g., folded substrate). The interface tab 202 and greeting card portion 204 are both constructed similarly to the interface tab 102 and greeting card portion 104 of FIG. 1. The interface tab 202 is attached to the greeting card portion 204 along a fold line 206. The fold line 206 is utilized in place of a perforated line, as illustrated with respect to the greeting card of FIG. 1. To be sure, the greeting card 200 of FIG. 2 can also include a perforated line as opposed to a fold line.

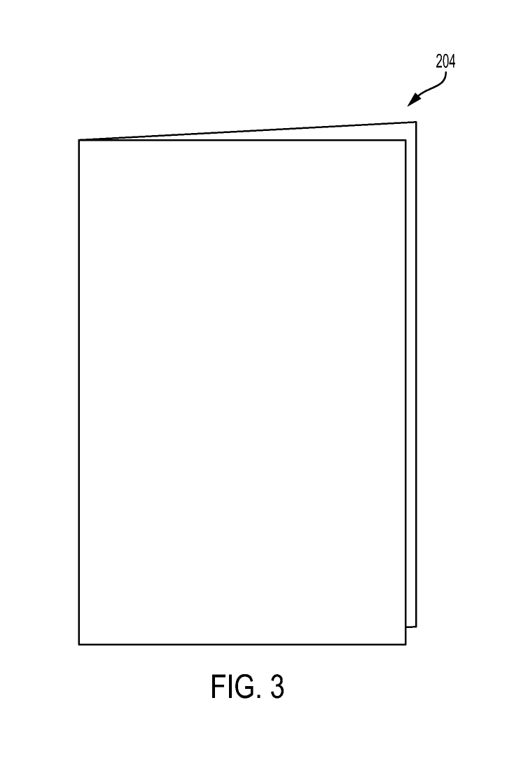

Because the greeting card 200 comprises a folding line 206, the interface tab 202 can be cut away from the greeting card portion 204 with a cutting implement such as scissors or a knife, to create a greeting card as illustrated in FIG. 3. If a clean edge is not required, the interface tab 202 can be removed from the greeting card portion 204 by tearing.

FIGS. 4-5 collectively illustrate the greeting card 200 in combination with a bottle 208. The interface tab 202 is disposed at an angle A relative to the greeting card portion 204 due to bending of the interface tab 202 and greeting card portion 204 at the fold line 206. A neck 210 of the bottle 208 is received in an aperture 212 of the interface tab 202.

In more detail, the interface tab 202 is disposed at angle A which is measured relative to a plane P extending in parallel with the greeting card portion 204. The exact details of angle A will depend upon the physical configuration of the bottle 208. It is advantageous to set the angle A such that the greeting card portion 204 lies flat against, or at least substantially parallel with the body of the bottle 208.

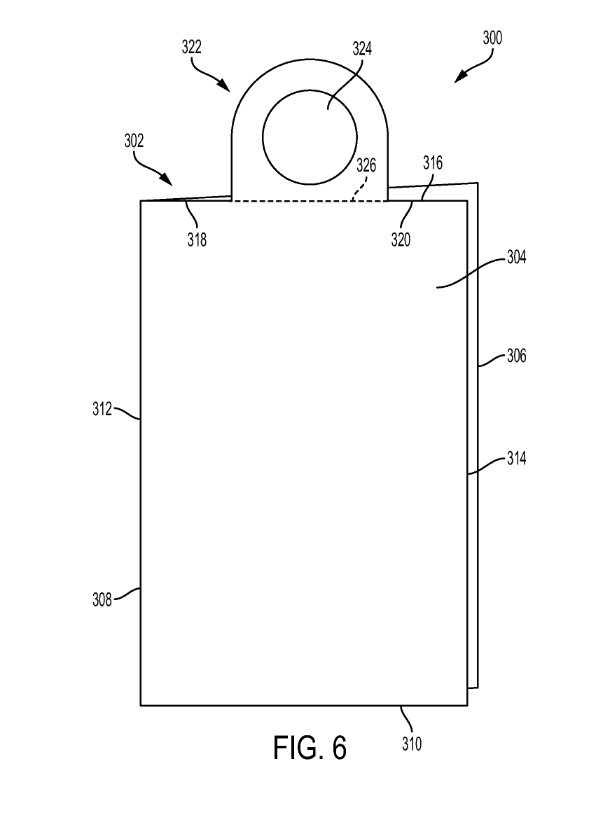

FIG. 6 illustrates another example greeting card 300, constructed in accordance with the present disclosure. The greeting card 300 comprises a folded substrate 302 that forms a front section 304 and a back section 306. The front and back sections 304 and 306 are defined by a folding line 308.

The front section 304 includes a bottom edge 310, opposing side edges 312 and 314, as well as a top edge 316. In some embodiments the top edge 316 comprises two linear sections 318 and 320 that are parallel to the bottom edge 310.

An arcuate tab 322 extends between the two linear sections 318 and 320. In some embodiments, the arcuate tab 322 comprises an aperture 324 that receives a neck of a bottle, as with other embodiments described herein.

In this embodiment, a perforated line 326 extends between and in alignment with the two linear sections 318 and 320. The folded substrate 302 is detachable from the arcuate tab 322 along the perforated line 326.

The folded substrate 302 can be manufactured from any suitable substrate such as paper, a textile, cardstock, a laminated paper, a plastic, or other similar material that would be known to one of ordinary skill in the art with the present disclosure before them.

FIGS. 7-9 collectively illustrate an example process for creating a greeting card product. The process comprises a step of obtaining a substrate 400 such as paper, a textile, cardstock, a laminated paper, a plastic, or other similar material.

The process includes defining a midline axis MA for the substrate 400. The method then includes forming an interface tab 402 on one side of the midline axis MA. In some embodiments an aperture 404 is created on the interface tab 402. As mentioned herein, the aperture receives a neck of a bottle.

In some embodiments, the interface tab 402 is formed by removing section 408 through any process such as die cutting, laser cutting, stamping, or other similar processes. The aperture 404 can be formed during the cutting process as well. This process creates a greeting card product blank. The greeting card product blank can be transformed into the greeting card product by folding the substrate 400 along the midline axis MA to form a greeting card product 410.

In some embodiments, the process includes creating a perforated line 412 that separates the interface tab 402 from a body 414 of a greeting card section 416.

According to some embodiments, the process can comprise folding the interface tab 402 at an intersection point IP where interface tab 402 meets the greeting card section 416. The folding of the interface tab 402 at an intersection point IP sets an angle between the interface tab 402 and the greeting card section 416, as with the embodiments of FIGS. 4 and 5.

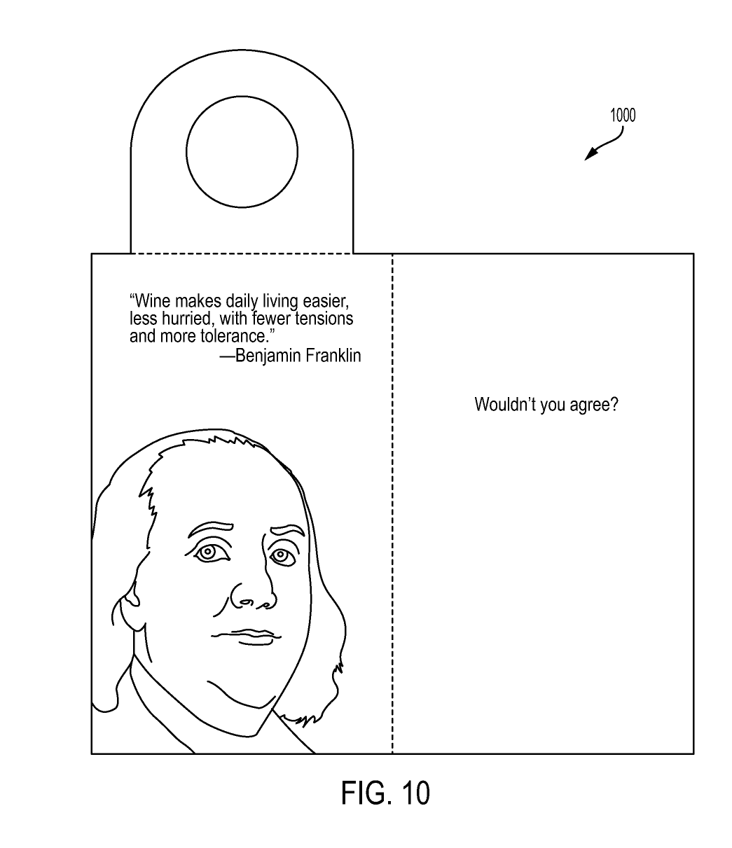

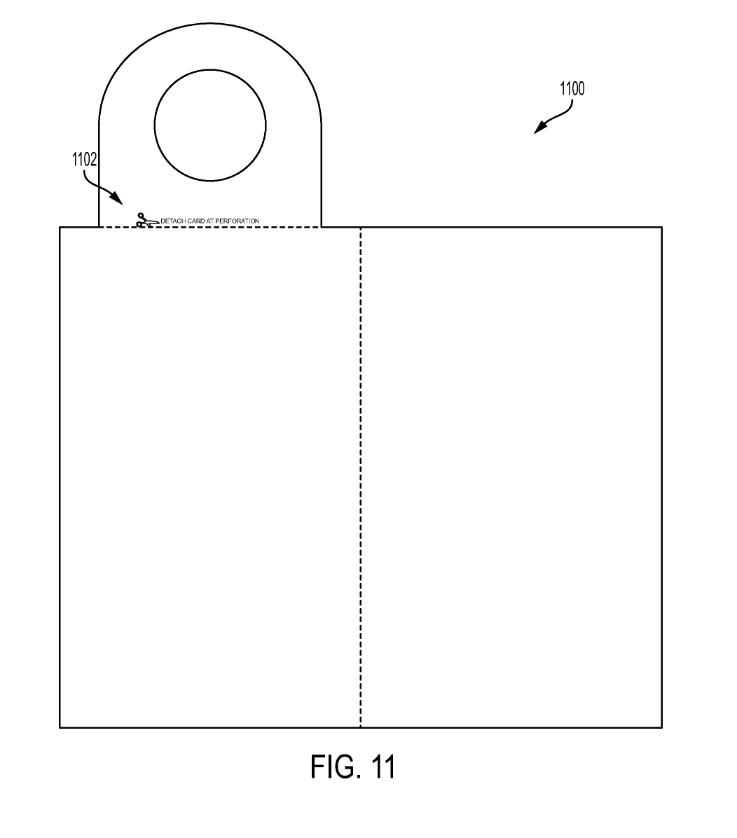

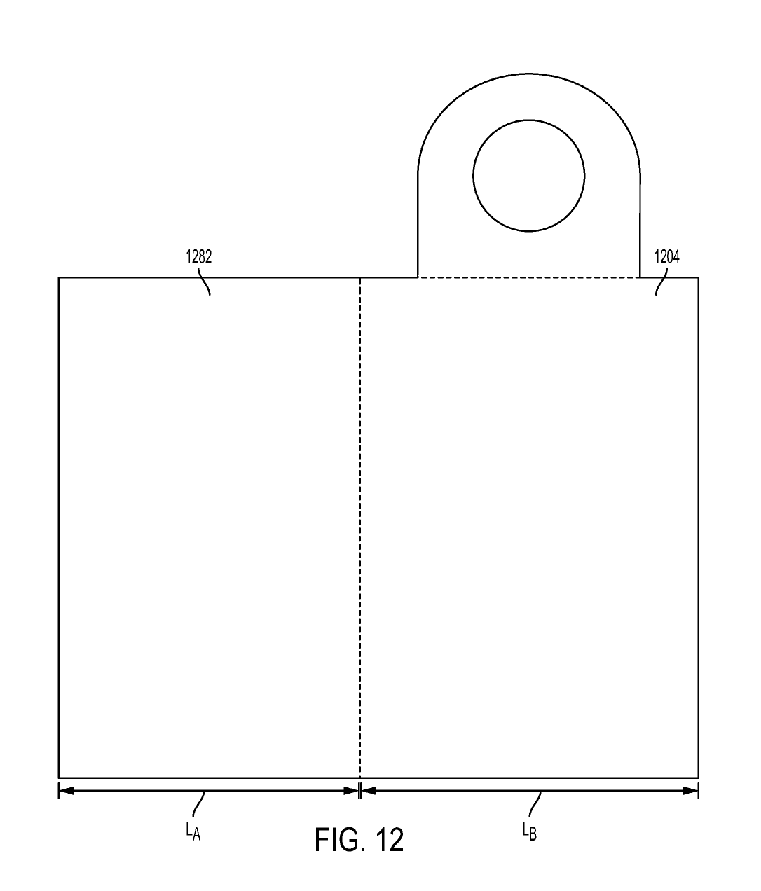

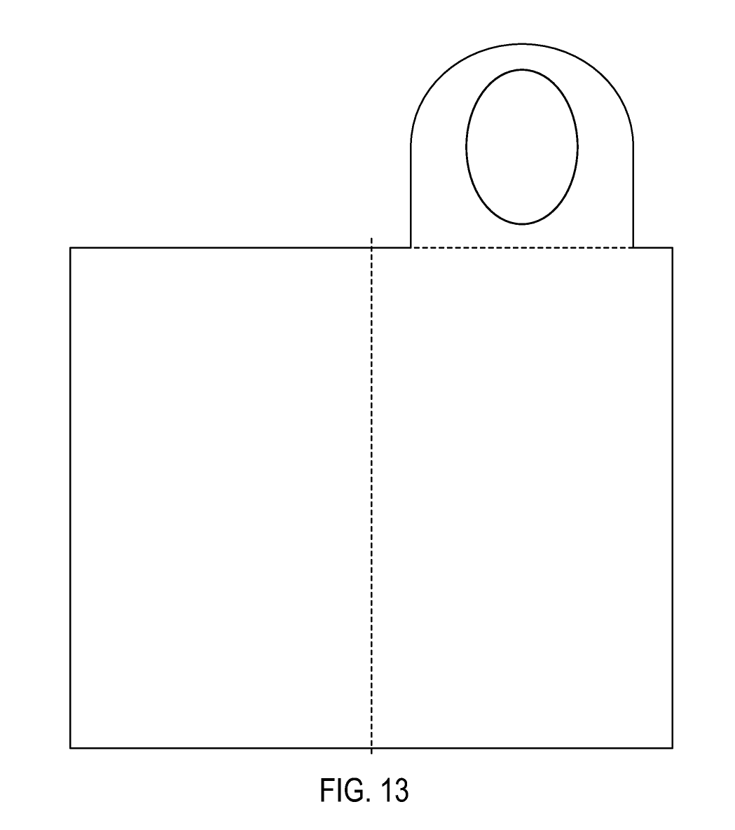

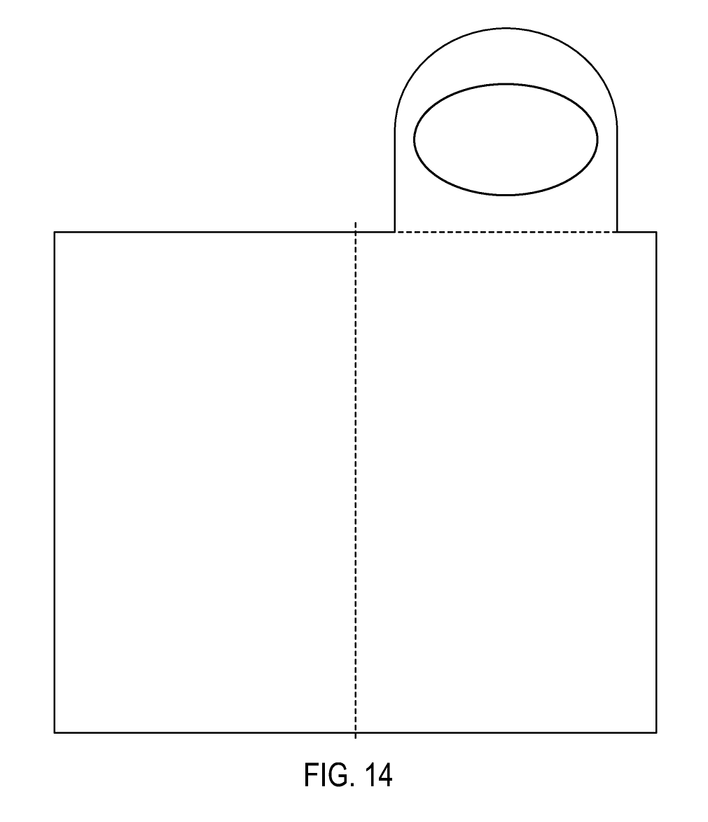

FIG. 10 illustrates an example greeting card product 1000 of the present technology that comprises indicia printed on the front and back sections. FIG. 11 is a front elevational view of an example greeting card product 1100 with instructions 1102 for removing an interface tab. FIG. 12 is a front elevational view of an example greeting card product having front and back sections of differing size. For example a front section 1282 has a length LA that is smaller in magnitude than a length LB of the back section 1204. To be sure, the differences between LA and LB allow at least a portion of the inner surface of the back section 1204 to be viewable even when the front section 1284 is folded to overlap the back section 1204. Also, it is noteworthy to mention that the example interface tab that couples the greeting card product to a bottle neck is attached to the back section 1204.

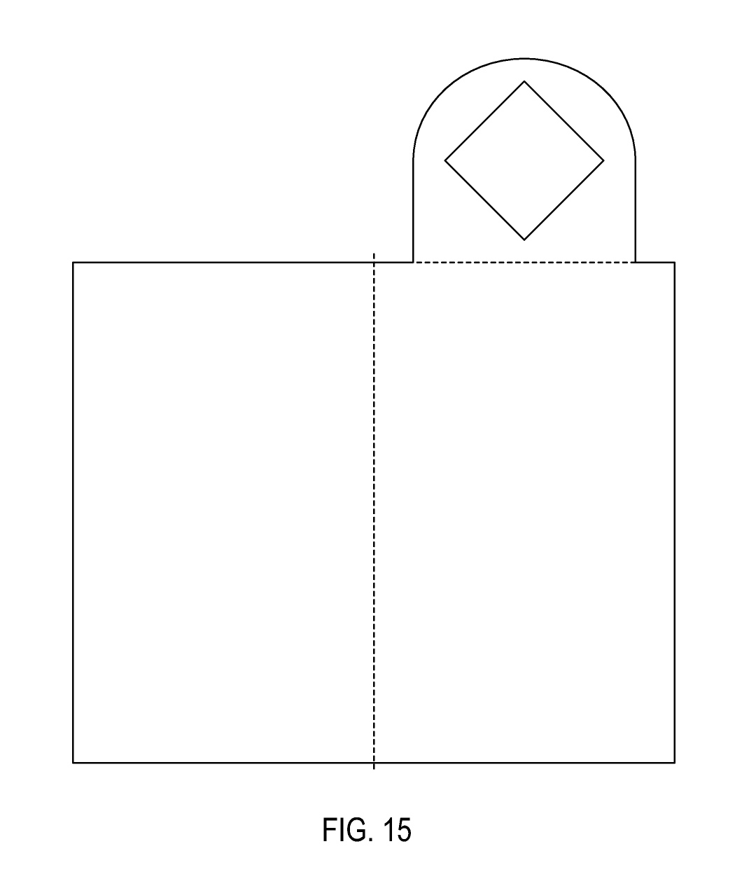

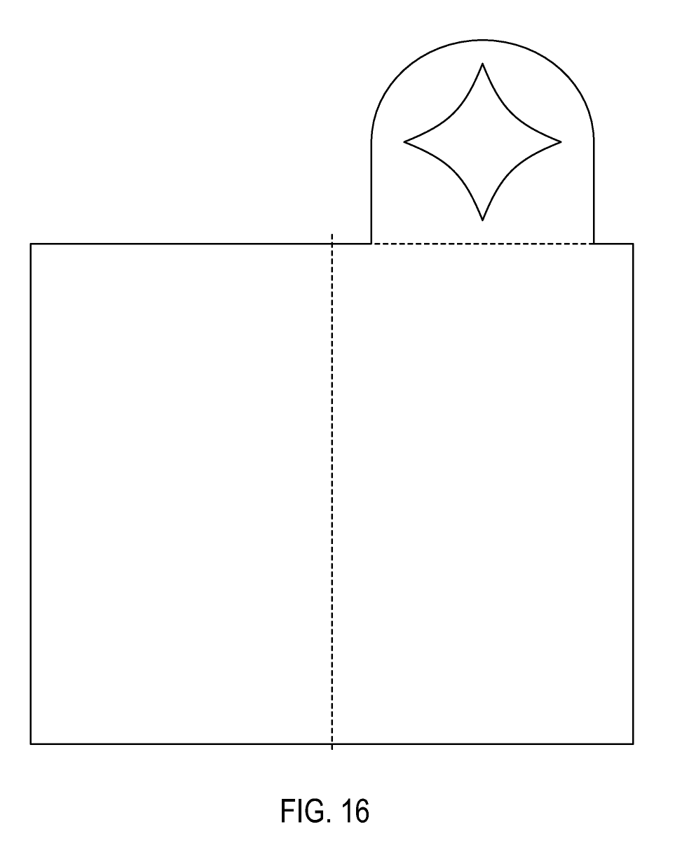

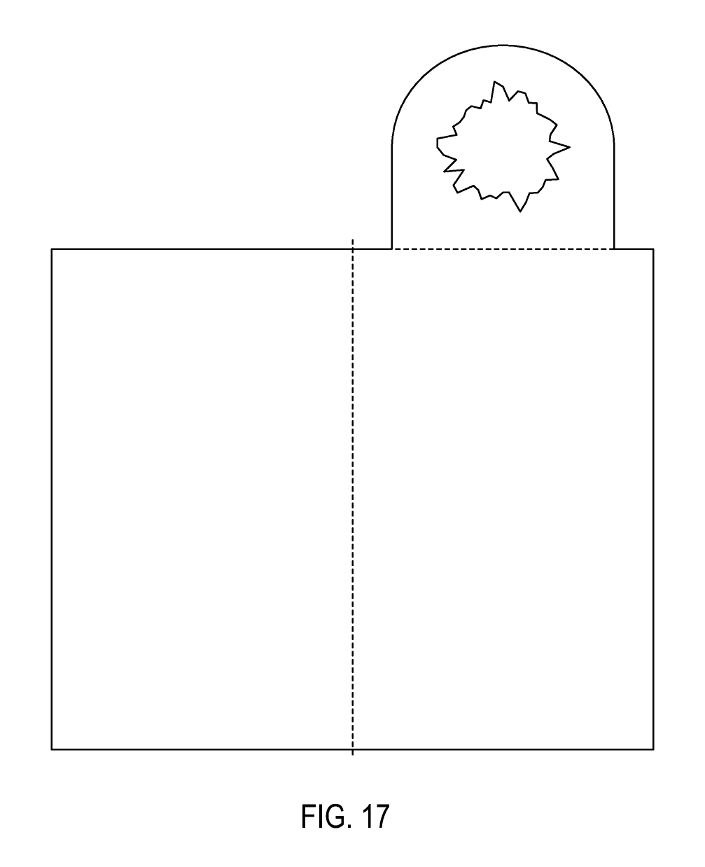

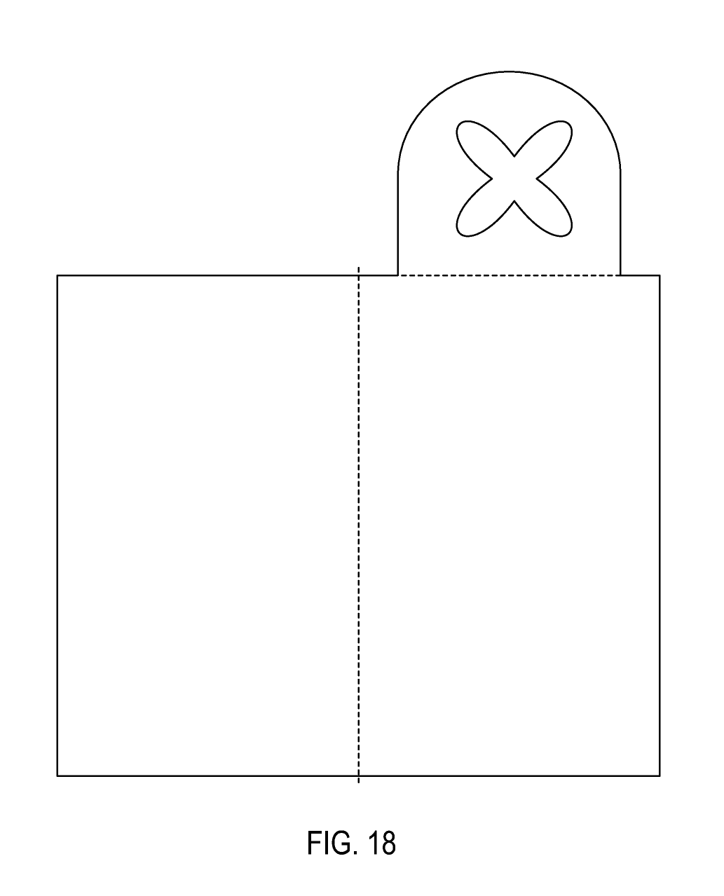

FIG. 13 illustrates an example greeting card product having an interface tab with a vertically oriented, oblong aperture. FIG. 14 illustrates an example greeting card product having an interface tab with a horizontally oriented, oblong aperture. FIG. 15 illustrates an example greeting card product having an interface tab with a diamond shaped aperture. FIG. 16 illustrates an example greeting card product having an interface tab with a star shaped aperture. FIG. 17 illustrates an example greeting card product having an interface tab with an irregularly shaped aperture.

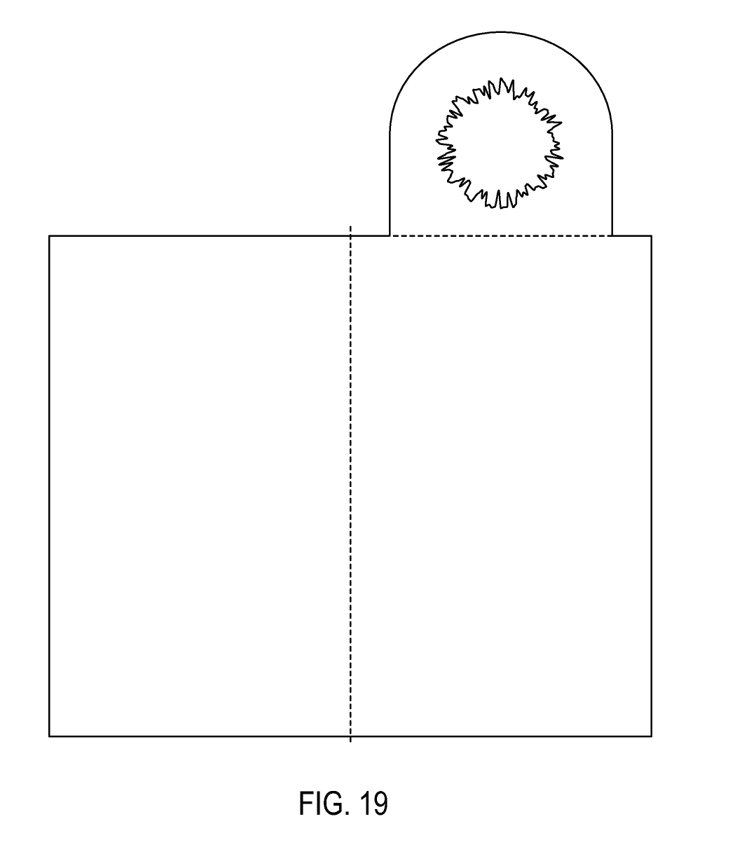

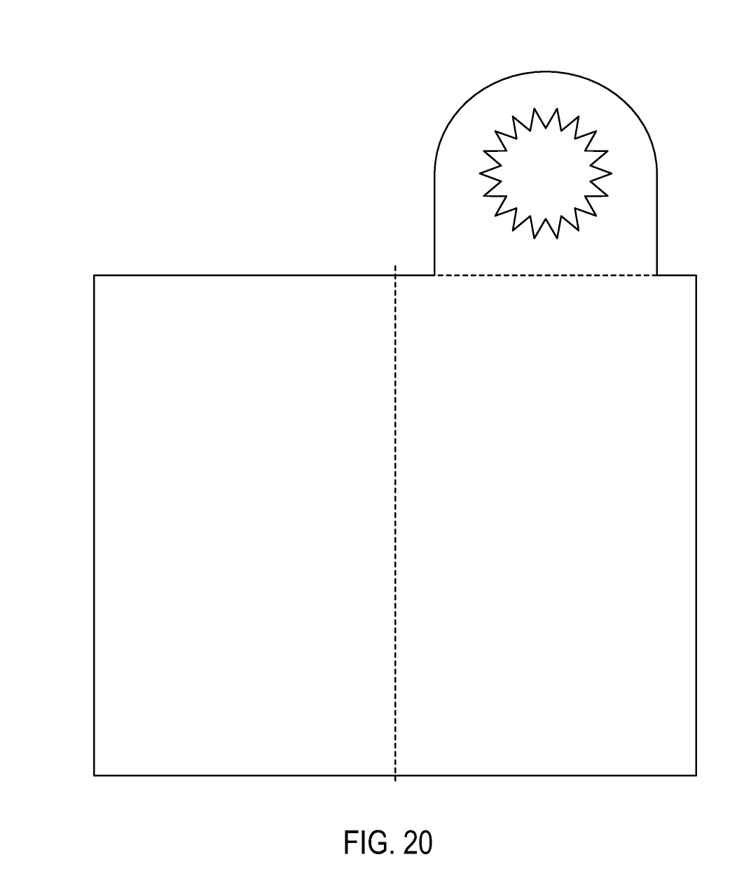

FIG. 18 illustrates an example greeting card product having an interface tab with a clover shaped aperture. FIGS. 19-20 each illustrate an example greeting card product having an interface tab with additional irregularly shaped apertures.

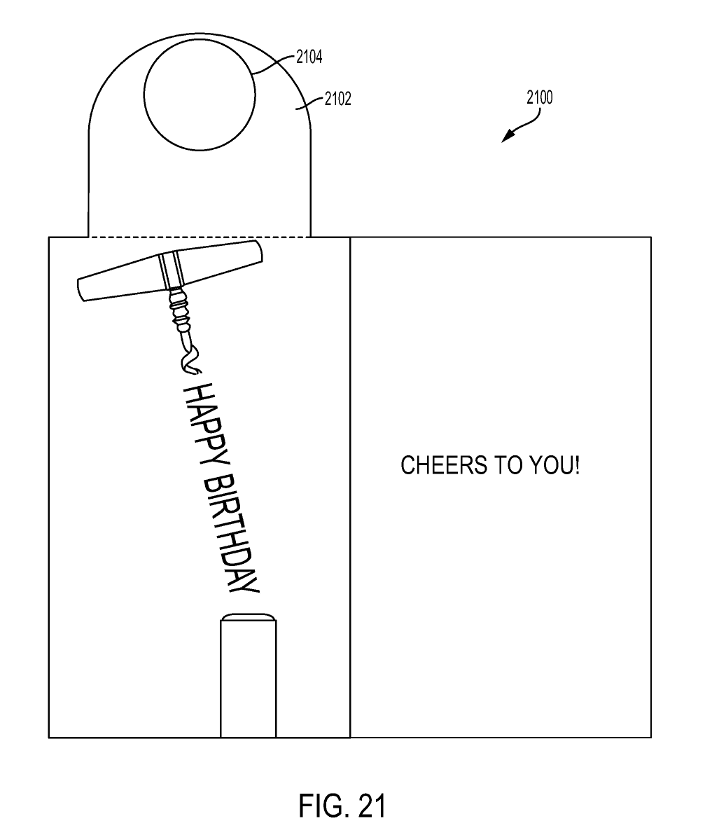

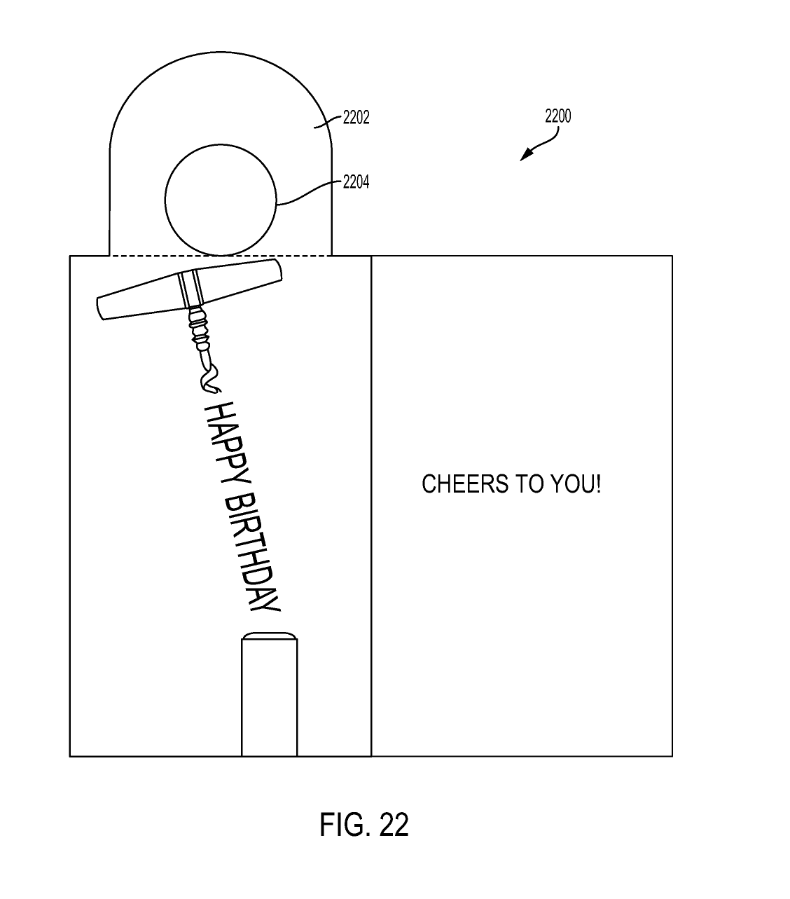

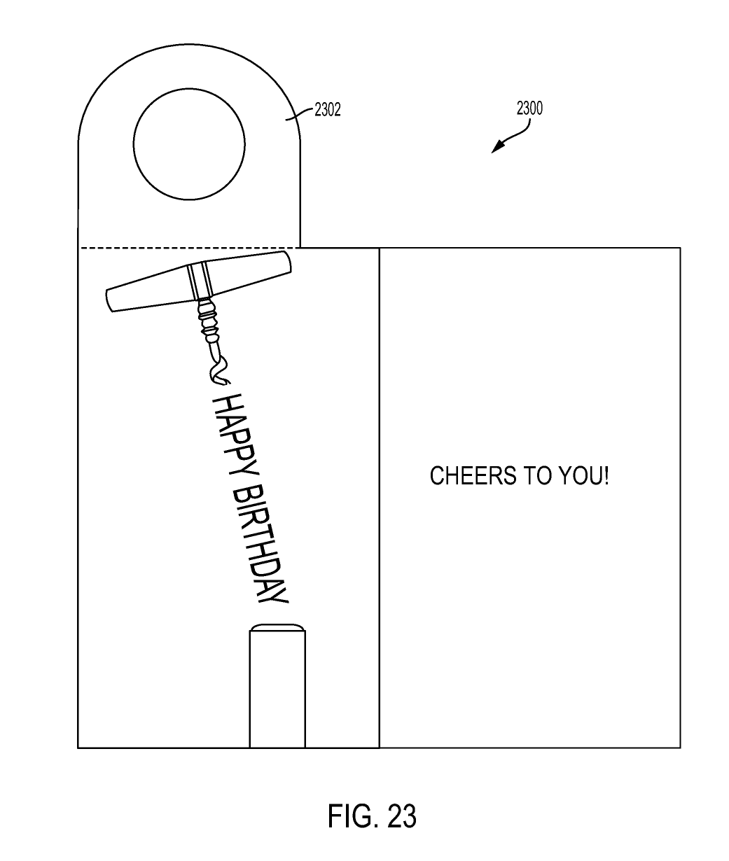

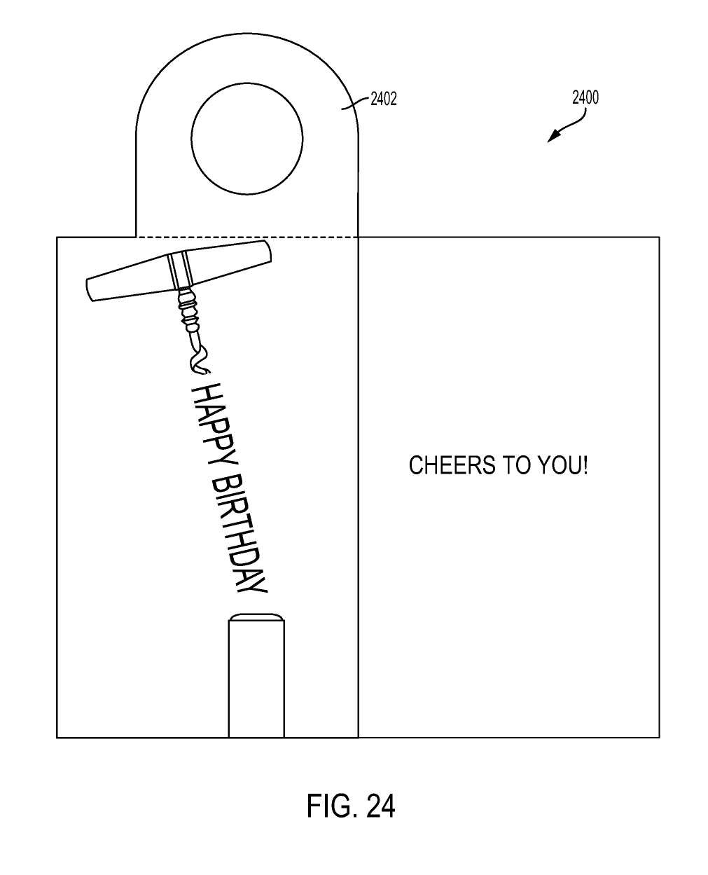

FIG. 21 is a front elevational view of an example greeting card product 2100 having an interface tab 2102 with an aperture 2104 disposed towards a top thereof. FIG. 22 is a front elevational view of an example greeting card product 2200 having an interface tab 2202 with an aperture 2204 disposed towards a bottom thereof, proximate a tear line. FIG. 23 is a front elevational view of an example greeting card product 2300 having an interface tab 2302 that is disposed on a first side of a front section (e.g., away from the midline). FIG. 24 is a front elevational view of an example greeting card product 2400 having an interface tab 2402 that is disposed on a second side of a front section, opposite to what is illustrated in FIG. 23.

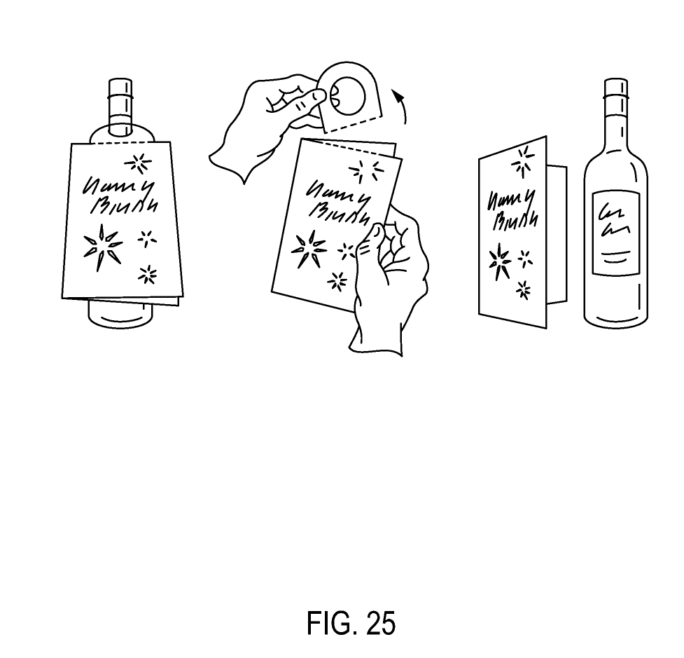

FIG. 25 is a diagrammatical representation of a process for using an example greeting card product. As illustrated, a greeting card product is disposed onto the neck of a bottle. For example a user can give the bottle and greeting card product as a gift to another individual. The recipient can keep the greeting card by tearing off the interface tab to create a greeting card. The greeting card is thus separate from the wine bottle and can be retained as a gift.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/ or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A greeting card, comprising:
a folded substrate forming a front section and a back section, the front section comprising a front surface and the back section comprising a rear surface; and
an interface tab configured to slip over a neck of a bottle, the interface tab extending from the front section in such a way that the front section remains folded over the back section when the interface tab is placed over the neck of the bottle, wherein a perforated line separates the interface tab from the front section of the folded substrate such that the folded substrate is detachable from the interface tab to form a greeting card.

2. The greeting card according to claim 1, wherein the interface tab comprises an aperture that receives the neck of the bottle.

3. The greeting card according to claim 1, wherein a centerline of the interface tab and a centerline of the front section are aligned with one another.

4. The greeting card according to claim 1, wherein the front section comprises a top surface with a length, wherein the interface tab has a tab length that is less than the length of the top surface.

5. The greeting card according to claim 1, wherein the interface tab has a substantially arcuate outer peripheral edge.

6. The greeting card according to claim 1, wherein the folded substrate comprises two inner surfaces, wherein at least one of the two inner surfaces is adapted to receive written indicia therein.

7. A greeting card, comprising:
a folded substrate; and
an interface tab configured to slip over a neck of a bottle, the interface tab extending from the folded substrate, wherein a perforated line separates the interface tab from the folded substrate, wherein the folded substrate bends and is disposed at an angle relative to the interface tab when the interface tab is placed over the neck of the bottle, wherein an inner surface of the folded substrate is comprised of a material that is not conducive to receiving written indicia, further wherein the inner surface comprises a coating or layer that receives written indicia.

8. The greeting card according to claim 7, wherein the interface tab comprises an aperture that receives the neck of the bottle.

9. The greeting card according to claim 8, wherein a centerline of the interface tab and a centerline of a front section of the folded substrate are aligned with one another.

10. The greeting card according to claim 9, wherein the front section comprises a top surface with a length, wherein the interface tab has a tab length that is less than the length of the top surface.

11. The greeting card according to claim 10, wherein the interface tab has a substantially arcuate outer peripheral edge.

12. (canceled)

13. A greeting card, comprising:
a folded substrate forming a front section and a back section defined by a folding line, the front section being folded over the back section along the folding line, wherein the front section comprises a bottom edge, opposing side edges, and a top edge, wherein the top edge comprises:
two linear sections that are parallel to the bottom edge;
an arcuate tab that extends between the two linear sections, the arcuate tab comprising an aperture that receives a neck of a bottle; and
a perforated line on the front surface, extending between, and in alignment with, the two linear sections, the folded substrate detachable from the arcuate tab along the perforated line, the arcuate tab being offset from a midline axis of the folded substrate so as to allow the folded substrate to hang from a neck of a bottle at an angle when the arcuate tab is placed over the neck of the bottle.

14. A greeting card product created by a process, the process comprising:
obtaining a substrate;
defining a midline axis of the substrate;
forming an interface tab on one side of the midline axis, the interface tab comprising an aperture that receives a neck of a bottle, wherein the interface tab is offset from a midline axis of the folded substrate; and
folding the substrate along the midline axis to form a greeting card product.

15. The process according to claim 14, further comprising creating a perforated line that separates the interface tab from a body of a greeting card section of the greeting card product.

16. The process according to claim 14, further comprising folding the interface tab at an intersection point where interface tab meets a greeting card section of the greeting card product.
